(19) United States
(12) Patent Application Publication
(10) Pub. No.: US 2024/0375010 A1
(43) Pub. Date: Nov. 14, 2024

(54) TUNABLE AGENT BEHAVIORS THROUGH CONTINUOUS REWARD WEIGHT-BASED GOAL SPACES

(71) Applicant: Sony Group Corporation, Tokyo (JP)

(72) Inventors: Florian Fuchs, Zürich (CH); Craig Sherstan, Tokyo (JP); Takuma Seno, Tokyo (JP); Yunshu Du, Denver, CO (US); Patrick MacAlpine, Austin, TX (US); Alisa Devlic, Stockholm (SE); Kaushik Subramanian, Metzingen (DE); Peter Wurman, Acton, MA (US)

(21) Appl. No.: 18/313,871

(22) Filed: May 8, 2023

(51) Int. Cl. A63F 13/67; A63F 13/803

(52) U.S. Cl. CPC A63F 13/67; A63F 13/803

(57) ABSTRACT

A single policy can be trained to handle the user selection of parameters across a predetermined range for each component of an artificial intelligent agent within a domain. The agent can be trained across a number of weights within the desired range for each component. These weights determine how much of a reward portion for each component should be considered by the agent during training. Thus, an improved formulation can be realized for UVFA-like goals based on compositional reward functions parameterized by their components' weights. Additionally, a set of reward components has been determined for the domain of autonomous racing games that, when combined with the improved UVFA formulation, allows training a single racing agent that generalizes over continuous behaviors in multiple dimensions. This can be used by game designers to tune the skill and personality of a trained agent.

### BACKGROUND OF THE INVENTION

### 1. Field of the Invention

Embodiments of the invention relate generally to systems and methods of reinforcement learning. More particularly, embodiments of the invention relate to methods and systems for universal value function approximators (UVFA)-like goals based on compositional reward functions parameterized by their components' weights.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In the field of Reinforcement Learning, value functions V^{π} (s) are used to model the expected future reward for an agent starting in a state s and following a policy π. This value function is then either used by the agent to directly decide on an action to take or to inform and stabilize the learning process of a separate policy function in an actor-critic setting.

Universal value function approximators (UVFA), V^{π} (s,g), are an extension of value functions that are additionally conditioned on a goal g, i.e., they estimate the future rewards starting from state s with the reward function depending on the active goal g. This allows a UVFA-based agent to learn how to best behave under multiple goals and potentially generalize to unseen goals. Exemplary goals for UVFA include a discrete set of goal states (e.g., 2D goal positions in a grid world with the agent rewarded for reaching the active goal position); or a vector representation of arbitrary pseudo-reward functions.

In view of the foregoing, there is a need for improved formulation for UVFA-like goals based on compositional reward functions parameterized by their components' weights

### SUMMARY OF THE INVENTION

Aspects of the present invention provide an improved formulation for UVFA-like goals based on compositional reward functions parameterized by their components' weights. Additionally, aspects of the present invention provide a set of reward components for the domain of autonomous racing games that, when combined with the improved UVFA formulation, allows training a single racing agent that generalizes over continuous behaviors in multiple dimensions. This can be used by game designers to tune the skill and personality of a trained agent.

Embodiments of the present invention provide a method and a non-transitory computer readable storage medium tangibly embodying a computer readable program code having computer readable instructions that, when executed, causes a computer device to carry out the method of training an artificial intelligent agent that generalizes over continuous behaviors in multiple dimensions, wherein the method comprises defining a reward function based on a state and an action as a linear combination of a plurality of component reward functions and a weight for each of the plurality of component reward functions; sampling multiple dimensions of the weight for each of the plurality of component reward functions from a continuous distribution between a maximum weight and a minimum weight; and training a single policy of the artificial intelligent agent over a continuous goal space including a plurality of parameterized reward functions represented by the continuous distribution of the weight for each of the plurality of component reward functions.

Embodiments of the present invention provide a method for providing an artificial intelligent agent in a racing game that is tunable to one or more skill components and/or one or more personality components comprising defining a reward function based on a state and an action as a linear combination of a plurality of component reward functions and a weight for each of the plurality of component reward functions; sampling multiple dimensions of the weight for each of the plurality of component reward functions from a continuous distribution between a maximum weight and a minimum weight; training a single policy of the artificial intelligent agent over a continuous goal space including a plurality of parameterized reward functions represented by the continuous distribution of the weight for each of the plurality of component reward functions, wherein the plurality of component reward functions include a base reward, motivating the artificial intelligent agent to finish a race in a minimal time, and one or more additional component reward functions, providing the one or more skill components and/or the one or more personality components.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates input modifications of the actor network of an exemplary quantile regression soft actor-critic (QR-SAC) algorithm to inform the agent on reward weights, according to an illustrative embodiment;

FIG. 2 illustrates input modifications of the critic network of an exemplary quantile regression soft actor-critic (QR-SAC) algorithm to inform the agent on reward weights, according to an illustrative embodiment; and

FIG. 3 provides a functional block diagram illustration of a computer hardware platform that can be used to implement a particularly configured computing device that can host an AI agent training engine.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms)

used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods to develop artificial intelligence (AI) policies for artificial agents for various domains, including gaming domains, such as racing games. The behavior of such AI agents can be user selected at run time by selecting parameters for a plurality of different factors. A single policy can be trained to handle the user selection of parameters across a predetermined range for each component. The agents can be trained across a number of weights within the desired range for each component. These weights determine how much of a reward portion for each component should be considered by the agent during training. Thus, an improved formulation can be realized for UVFA-like goals based on compositional reward functions parameterized by their components' weights. Additionally, a set of reward components has been determined for the domain of autonomous racing games that, when combined with the improved UVFA formulation, allows training a single racing agent that generalizes over continuous behaviors in multiple dimensions. This can be used by game designers to tune the skill and personality of a trained agent.

When AI policies are developed for different games, different players are playing with different skill levels. Thus, when playing against an AI agent, a player often desires this agent to play at a skill level at least equal to that of the player. Aspects of the present invention provide reinforcement learning training processes to define what playing at different levels mean, where behaviors can be tuned by using an AI approach.

For example, one component may describe the aggressiveness of an agent in a racing game. The reward function may be based on the number of collisions made by the agent during a race, where a reward may be provided. Thus, a higher reward may be provided for more collisions when an aggressive driving agent is desired. A policy can be trained across a range of rewards so that the user, at run time, can select an aggressiveness component for the agent against which they are racing. Thus, instead of training multiple policies, for example, for low, medium and high aggressiveness, a single policy can be realized for this component, as well as additional components, for the agent.

As discussed in greater detail below, aspects of the present invention provide the ability to train an agent across a plurality of weights for various components of the domain, such as a racing game domain, where the weight becomes an input to the neural network, so that the weight can be chosen at run time by the user. In some embodiments, the weighting can be provided as an input to both the policy and the Q-function. While inputting the weighting into the Q-function is not required in all aspects of the present invention, such an input may help achieve the learning during the training in a more stable fashion.

In some embodiments, the agent is trained in a training step so that the user can select parameters during game play. In other embodiments, the agent may also be trained during game play as well, where the user can pick parameters for game play and these results can be fed back into neural network to update the policy as needed. For example, if the user selects an aggressiveness level of 5 (on a scale of 1 to 10, for example), and the agent performs with a number of collisions greater than that desired for the selected level, this information may be fed back to the network so that the policy may be updated appropriately to further limit the number of collisions at this selected level for this selected component.

### Continuous Reward Weights as Goal Space

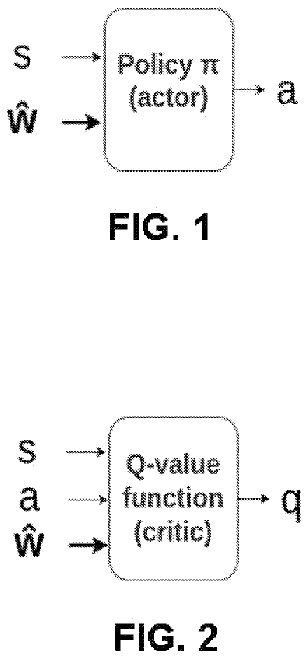

Referring to FIGS. 1 and 2, an environment's reward function R can be defined based on state s and action a as a linear combination of m components, as is done in many, if not most, Reinforcement Learning (RL) applications:

$$R ( s , a ) := {\sum }_{i = 1}^{m} {w}_{i} {R}_{i} ( s , a )$$

where wᵢ is a scalar component weight and Rᵢ(s, a) is the reward function for the i-th component. Usually, RL applications keep w fixed as a single scalar vector during an experiment and often search for the w best suited for their application over multiple experiments. Aspects of the present invention, however, can train an agent over a continuous goal space including parameterized reward functions represented by their weights.

Instead of keeping w fixed, aspects of the present invention can sample one or multiple dimensions i of w from a continuous (e.g. uniform) distribution. This subset of non-fixed dimensions of w can be denoted as ŵ. To put more emphasis on a specific weight or segment of a weight range and improve the agent's performance for that segment, skewed distributions may be used, such as a log-uniform distribution. For the basic version of the approach, ŵ can be sampled once per training rollout at the beginning of the episode and it can be kept fixed thereafter.

As a possible extension, it is proposed to additionally repeatedly re-sample ŵ during a rollout, such that the agent becomes robust to reward function changes during ongoing trajectories.

To inform the trained agent of the reward function it is operating under, ŵ can be provided as an additional input to both the policy (actor) and value functions (critic) of the training algorithm. The neural network policy can be updated from π(s) to π(s,ŵ) and the action-value function Q(s, a) to Q(s, a, ŵ) by concatenating the non-fixed reward component weights with the rest of the inputs.

When evaluating the agent's policy at inference time, ŵ can then be set to any of the weights covered during training and the agent can adapt its behavior accordingly and strive to behave optimally under the represented reward function without any retraining.

### Reward Parts to Influence an Autonomous Racing Agent's Driving Behavior

Aspects of the present invention provide a set of reward parts that can be used in combination with the previously defined reward weight-based goal formulation for the domain of designing autonomous opponents for racing games. Those reward parts allow the encoding of different desired behavior types into the reward function. The progress along the racing course centerline achieved by the agent can be used in an environment step as a base reward to motivate the agent to finish the race course as quickly as possible. The sampled weights for the novel reward parts ŵ then describe the importance of those parts in relation to the fixed weight progress reward. The following reward parts are proposed to be used in addition to the progress reward, either individually or in combination with each other: (1) A penalty for the degradation of the agent's car tires during an environment step. This motivates the agent to save its tires and drive more conservative trajectories similar to careful human drivers, resulting in slower trajectories; (2) A penalty for the agent's fuel use during an environment step. This motivates the agent to drive more economical and smoother trajectories with less extreme changes in speed; (3) A linear penalty for tire slip ratios and angles. This motivates the agent to reduce the chance of slipping and therefore drive safer trajectories similar to those of novice or careful human drivers, that brake earlier before heading into a curve and accelerate later when exiting the curve, which results in a slower trajectory overall; (4) A linear positive reward for tire slip ratio and angle. This motivates the agent to drift, especially in curves where drifting still allows achieving a relatively high progress reward; (5) An edge distance penalty that linearly increases with the agent's proximity to the racing track edge. By setting the weight of this reward, one can influence how much of the track's width the agent uses; (6) A set of reward parts penalizing an agent for driving in corresponding slices of the track defined by the distance to the centerline, e.g., centerline to 2 m from centerline, 2 m to 4 m, 4 m to 6 m, and the like. Based on the weights configured for those reward parts during inference, a game designer can influence the agents driving line post training; (7) A passing reward with independently weighted positive and negative parts for overtaking and being overtaken by other cars respectively. By varying the weights for these rewards individually, an agent can be trained either keen on passing opponents or defending against being overtaken; (8) A penalty on the change in steering angle during an environment step. This motivates the agent to reduce steering changes, resulting in smoother steering movements and earlier braking points to manage driving through curves with smaller steering ranges; (9) A penalty for colliding with other vehicles. Based on this penalty's weight we can tune the agent's aggressiveness and assertiveness nearby other drivers; and (10) A penalty for the car driving off course, either measured by the center of the car or its tires. Based on this penalty's weight, one can tune how often an agent violates track boundaries or, when used with a relatively high weight, how close to the track's edge an agent drives.

### Advantages of Continuous Reward Weights to Tune Agent Behavior

(1) Scaling of agent behavior and design of driver personalities post training. A game designer can configure the behavior of an agent trained with embodiments of the present invention along multiple axes including, carefulness and aggressiveness. for example, without the need to retrain the policy each time. This way. the designer can. for example. adjust the skill of an agent to a human player's skill by setting the weight of previously introduced reward parts, such as the tire slip penalty, accordingly during game play. In addition to that, a game designer can design agent personalities based on the driving style represented by a certain choice of reward weights. They can, for example, configure a careful and respectful driver by increasing the tire slip and collision penalty weights or even tune the weights to match the driving style of a famous real-world racing driver. By allowing the game designer to tune those behaviors to their liking post training, they have more freedom in the design process and reduce their dependence on the Reinforcement Learning specialists that trained the agent.
(2) Support of context-based reward weights for in-game behavior tweaking. By re-sampling reward weights mid-rollout during training, aspects of the present invention can train agents that are robust to online reward weight changes. This allows a game designer to update the agent's behavior in an ongoing game. This can. for example, be used in combination with the tire slip penalty to change the agent's overall speed based on its distance to a human driver by increasing the tire slip penalty's weight when the agent gains too much distance on a human driver and decreasing it when the agent is lagging too far behind.
(3) Shared neural network inference for multiple differently behaving agents. The neural network policy trained with this approach encodes a continuous range of agent behaviors within a single set of shared network weights. When running multiple different reward weight configurations of such an agent next to each other, this allows to easily parallelize the network forward pass which effectively reduces the inference time of multiple agents with different behaviors to the time it takes to run inference for a single agent. Additionally, only a single neural network needs to be loaded into memory to run multiple agents with different behaviors. This significantly reduces memory consumption compared to using separately trained neural network policies for every desired agent behavior.
(4) Replace search over reward weights by single experiment. The approach, according to aspects of the present invention, allows an agent to learn over a continuous range of reward weights in a single training run. This can be used even when the goal is to finally only use a single fixed vector of reward weights during inference. With the approach according to aspects of the present invention, the time to search for the vector of reward weights that leads to a desired agent behavior can be significantly reduced. Instead of training a separate model from scratch for every reward weight combination of interest, aspects of the present invention can be used to cover a reward weight range of interest in a single training run and, afterwards, evaluate promising reward weight combinations, which is significantly faster and cheaper to do.
(5) Improve exploration of agents by exploring under varying reward weights. It is hypothesized that training an agent under the changing reward weights can improve the exploration process of the algorithm by providing the exploring agent with more diverse data in different reward weight settings. For example, when a collision penalty is used to train an agent that avoids collisions, the agent might learn to avoid collisions early on in the training process. This, however, leads to an increased sparsity in the collision penalty signal, leaving much less collision data to learn from for the rest of the training time. By simultaneously training the agent over a range of lower penalty weights, the agent can still collect data involving collisions from those lower weight rollouts. With this additional data, the agent is able to learn a more precise value function.

While the above disclosure focuses on the domain of a racing game, it should be understood that aspects of the present invention may be applied to AI agents used in various different domains. For example, the AI agent may be one in an animation or locomotion domain, where, for example, one of the components may be provided to change the weight of an energy cost to create slower, faster or more expressive walking of the AI agent. As another non-limiting example, in a fighting game, an AI agent may be trained with various proficiencies on various weapons, where a single policy may be able to provide a range of proficiencies on weapons, such as a bow, sword, axe or the like.

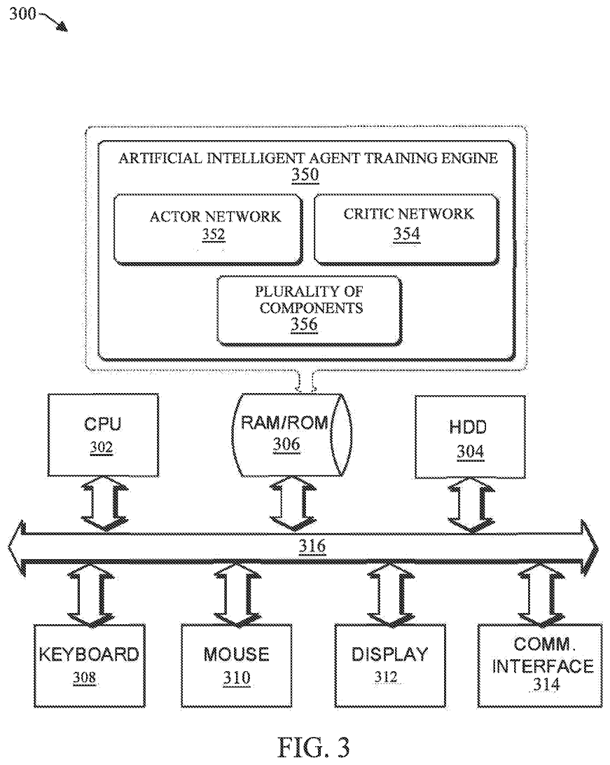

FIG. 3 provides a functional block diagram illustration of a computer hardware platform 300 that can be used to implement a particularly configured computing device that can host an AI agent training engine 350. The AI agent training engine 350, as discussed above, can include an actor network 352, an optional critic network 354 and a plurality of components 356 that can be each separately weighted for training an AI agent.

The computer platform 300 may include a central processing unit (CPU) 302, a hard disk drive (HDD) 304, random access memory (RAM) and/or read only memory (ROM) 306, a keyboard 308, a mouse 310, a display 312, and a communication interface 314, which are connected to a system bus 316.

In one embodiment, the HDD 304, has capabilities that include storing a program that can execute various processes, such as the AI agent training engine 350, in a manner to perform the methods described herein.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for training an artificial intelligent agent that generalizes over continuous behaviors in multiple dimensions, the method comprising:
defining a reward function based on a state and an action as a linear combination of a plurality of component reward functions and a weight for each of the plurality of component reward functions;
sampling multiple dimensions of the weight for each of the plurality of component reward functions from a continuous distribution between a maximum weight and a minimum weight; and
training a single policy of the artificial intelligent agent over a continuous goal space including a plurality of parameterized reward functions represented by the continuous distribution of the weight for each of the plurality of component reward functions.

2. The method of claim 1, further comprising improving a performance of the artificial intelligent agent over a segment of the continuous distribution of the weight by providing a skewed distribution of weight, wherein the training is performed over the skewed distribution of weight for one or more of the plurality of component reward functions.

3. The method of claim 2, wherein the skewed distribution of weight is a log-uniform distribution.

4. The method of claim 1, further comprising sampling the continuous distribution of weights once per training rollout at a beginning of an episode.

5. The method of claim 1, further comprising repeatedly re-sampling the continuous distribution of weights during a training rollout, wherein the artificial intelligent agent becomes robust to reward function changes during ongoing trajectories.

6. The method of claim 1, further comprising applying the continuous distribution of weights to both a policy and a value function of a training algorithm.

7. The method of claim 6, further comprising updating a neural network policy from π(s) to π(s,ŵ) and the action-value function Q(s, a) to Q(s, a, ŵ) by concatenating the continuous distribution of weights, ŵ with inputs related to state, s.

8. The method of claim 1, further comprising evaluating the single policy of the artificial intelligent agent at inference time by choosing a chosen weight for each of the plurality of component reward functions, wherein the artificial intelligent agent behaves accordingly under a chosen reward function without any retraining.

9. The method of claim 1, wherein the artificial intelligent agent operates in a racing game environment.

10. The method of claim 9, further comprising:
providing a base reward as one of the plurality of component reward functions, the base reward motivating the artificial intelligent agent to finish a race in a minimal time; and
providing one or more additional ones of the plurality of component reward functions to provide one or more skill component reward functions and/or one or more personality component reward functions.

11. The method of claim 10, wherein the continuous distribution of weights for the one or more additional ones describe an importance of each of the one or more additional ones in relation to a fixed weight for the base reward.

12. The method of claim 10, wherein the one or more additional ones of the plurality of component reward functions include at least one of the following:
(a) a penalty for degradation of car tires of the artificial intelligent agent during an environment step;
(b) a penalty for a fuel use by the artificial intelligent agent during an environment step;
(c) a linear penalty for tire slip ratios and angles;
(d) a linear positive reward for tire slip ratio and angle;
(e) an edge distance penalty that linearly increases with a proximity of the artificial intelligent agent to an edge of a racing track;
(f) a set of reward parts penalizing the artificial intelligent agent for driving in corresponding slices of the racing track defined by a distance to a centerline thereof;
(g) a passing reward with independently weighted positive and negative parts for overtaking and being overtaken by other cars, respectively;
(h) a penalty on a change in steering angle during an environment step;
(i) a penalty for colliding with other vehicles; and
(j) a penalty for a car of the artificial intelligent agent driving off course.

13. The method of claim 12, wherein each of the one or more additional ones of the plurality of component reward functions are defined within the single policy of the artificial intelligent agent.

14. A method for providing an artificial intelligent agent in a racing game that is tunable to one or more skill components and/or one or more personality components, the method comprising:
defining a reward function based on a state and an action as a linear combination of a plurality of component reward functions and a weight for each of the plurality of component reward functions;
sampling multiple dimensions of the weight for each of the plurality of component reward functions from a continuous distribution between a maximum weight and a minimum weight;
training a single policy of the artificial intelligent agent over a continuous goal space including a plurality of parameterized reward functions represented by the continuous distribution of the weight for each of the plurality of component reward functions, wherein
the plurality of component reward functions include a base reward, motivating the artificial intelligent agent to finish a race in a minimal time, and one or more additional component reward functions, providing the one or more skill components and/or the one or more personality components.

15. The method of claim 14, further comprising improving a performance of the artificial intelligent agent over a segment of the continuous distribution of the weight by providing a skewed distribution of weight, wherein the training is performed over the skewed distribution of weight for one or more of the plurality of component reward functions.

16. The method of claim 14, further comprising applying the continuous distribution of weights to both a policy and a value function of a training algorithm, wherein a neural network policy is updated from π(s) to π(s,ŵ) and the action-value function is updated from Q(s, a) to Q(s, a, ŵ) by concatenating the continuous distribution of weights, ŵ with inputs related to a state, s and an action, a.

17. The method of claim 14, further comprising evaluating the single policy of the artificial intelligent agent at inference time by choosing a chosen weight for each of the plurality of component reward functions, wherein the artificial intelligent agent behaves optimally under a chosen reward function without any retraining.

18. A non-transitory computer readable storage medium tangibly embodying a computer readable program code having computer readable instructions that, when executed, causes a computer device to carry out a method of training an artificial intelligent agent that generalizes over continuous behaviors in multiple dimensions, the method comprising:
defining a reward function based on a state and an action as a linear combination of a plurality of component reward functions and a weight for each of the plurality of component reward functions;
sampling multiple dimensions of the weight for each of the plurality of component reward functions from a continuous distribution between a maximum weight and a minimum weight; and
training a single policy of the artificial intelligent agent over a continuous goal space including a plurality of parameterized reward functions represented by the continuous distribution of the weight for each of the plurality of component reward functions.

19. The method of claim 18, wherein the artificial intelligent agent is part of a racing game environment.

20. The method of claim 18, further comprising evaluating the single policy of the artificial intelligent agent at inference time by choosing a chosen weight for each of the plurality of component reward functions, wherein the artificial intelligent agent behaves optimally under a chosen reward function without any retraining.
